(19) United States
(12) Patent Application Publication
(10) Pub. No.: US 2022/0185231 A1
(43) Pub. Date: Jun. 16, 2022

(54) Automobile Security System Aids in Passenger Heatstroke Prevention

(71) Applicant: US Gov't as represented by Secretary of Air Force, Wright-Patterson AFB, OH (US)

(72) Inventors: Victor K. Lee, Monterey Park, CA (US); Alexander I. Hess, Ebro, FL (US); Lucas Van Epps, San Diego, CA (US)

(21) Appl. No.: 17/142,633

(22) Filed: Jan. 6, 2021

Related U.S. Application Data
(60) Provisional application No. 63/123,714, filed on Dec. 10, 2020.

(51) Int. Cl. B60R 25/01; B60R 25/31; F02N 11/08; B60R 25/24; B60H 1/00

(52) U.S. Cl. CPC B60R 25/01; B60R 25/31; B60H 1/00642; B60R 25/24; F02N 11/087; F02N 11/0803

(57) ABSTRACT

A vehicle, system, and method provide determining whether a thermal risk exists for an occupant of a passenger compartment of a vehicle based on: identifying, via the temperature sensor, that the temperature within the passenger compartment is outside of a safe temperature range, identifying, via an electronic control module, that an engine of the vehicle is not running, and identifying, via the occupant sensor, that an occupant is in the passenger compartment. In response to determining that the thermal risk exists, a controller starts starting the engine via an ignition locking system, closes power-actuated windows of the passenger compartment, locks power-locked doors of the passenger compartment, and activates a heating, ventilation and air conditioning system of the vehicle via a climate control unit. The HVAC maintains the temperature of the passenger compartment within the safe temperature range to safeguard the occupant until return of a responsible party.

### CROSS-REFERENCE TO RELATED APPLICATIONS

This application claims the benefit of priority under 35 U.S.C. § 119(e) to U.S. Provisional Application Ser. No. 63/123,714 entitled “Automobile Security System Aids in Passenger Heatstroke Prevention,” filed 10 Dec. 2020, the contents of which are incorporated herein by reference in their entirety.

### ORIGIN OF THE INVENTION

The invention described herein was made by employees of the United States Government and may be manufactured and used by or for the Government of the United States of America for governmental purposes without the payment of any royalties thereon or therefore.

### BACKGROUND

### 1. Technical Field

The present disclosure generally relates to temperature alert and mitigation systems, and more particularly to temperature alert and mitigation systems for passenger vehicles.

### 2. Description of the Related Art

Passenger vehicles frequently carry vulnerable occupants such as infants or pets that are unable to exit the vehicle on their own. On certain occasions, a driver of the passenger vehicle inadvertently leaves the vulnerable occupant in the vehicle for a period of time in which a passenger compartment of the vehicle can be dangerously hot or dangerously cold, depending on the ambient conditions. Infants and pets can be injured or killed in such circumstances. Solutions have been proposed for generating alerts or causing air to circulate in a vehicle when an occupant is detected in a vehicle that is not running. However,

[symbol]

### SUMMARY

The present innovation overcomes the foregoing problems and other shortcomings, drawbacks, and challenges of vehicle occupant safety systems. While the present innovation will be described in connection with certain embodiments, it will be understood that the invention is not limited to these embodiments. To the contrary, this invention includes all alternatives, modifications, and equivalents as may be included within the spirit and scope of the present invention.

According to one aspect of the present innovation, a vehicle includes a heating, ventilation and air conditioning (HVAC) system that comprises and is managed by a climate control unit (CCU). The vehicle includes an engine that provides operative power to the ECM. The vehicle includes an ignition locking system (ILS) communicatively coupled to start and stop operation of the engine. The vehicle includes an electronic control module (ECM) that provides an operational status of the engine. The vehicle includes a passenger compartment that is maintained within a safe temperature range by the HVAC system. The vehicle includes power-locked doors that selectively allow access to the passenger compartment. The vehicle includes power-actuated windows that selectively allow external airflow into the passenger compartment. The vehicle includes a thermal injury prevention system having an occupant sensor, a temperature sensor, and a controller. The occupant sensor detects presence of a passenger in the passenger compartment. The temperature sensor detects a temperature within the passenger compartment. The controller is communicatively coupled to the CCU of the HVAC system, the ILS, the ECM, the power locked doors, the power-actuated windows, the occupant sensor, and the temperature sensor. The controller determines whether a thermal risk exists for an occupant of the passenger compartment based on: (i) identifying, via the temperature sensor, that the temperature within the passenger compartment is outside of a safe temperature range; (ii) identifying, via the ECM, that the engine is not running, and (iii) identifying, via the occupant sensor, that an occupant is in the passenger compartment. In response to determining that the thermal risk exists, the controller: (a) starts the engine via the ILS; (b) closes the power-actuated windows; (c) locks the power-locked doors; and (d) activates the HVAC via the CCU to maintain the temperature of the passenger compartment within the safe temperature range to safeguard the occupant until return of a responsible party.

According to one aspect of the present innovation, a thermal injury prevention (TIP) system includes an occupant sensor to detect presence of a passenger in a passenger compartment of a vehicle. The TIP system includes a temperature sensor to detect a temperature within the passenger compartment. The TIP system includes a HPM communicatively coupled to the occupant sensor and the temperature sensor and comprising a controller and one or more interfaces communicatively coupled to components of the vehicle. The components of the vehicle include an HVAC system that is managed by a CCU, an engine that provides operative power to the ECM, an ignition locking system (ILS) communicatively coupled to start and stop operation of the engine, an electronic control module (ECM) that provides an operational status of the engine, a passenger compartment that is maintained within a safe temperature range by the HVAC system, power-locked doors that selectively allow access to the passenger compartment, and power-actuated windows that selectively allow external airflow into the passenger compartment. The controller determines whether a thermal risk exists for an occupant of the passenger compartment based on: (i) identifying, via the temperature sensor, that the temperature within the passenger compartment is outside of a safe temperature range; (ii) identifying, via the ECM, that the engine is not running; and (iii) identifying, via the occupant sensor, that an occupant is in the passenger compartment. In response to determining that the thermal risk exists, the controller starts the engine via the ILS; closes the power-actuated windows; locks the power-locked doors; and activates the HVAC via the CCU to maintain the temperature of the passenger compartment within the safe temperature range to safeguard the occupant until return of a responsible party.

According to one aspect of the present innovation, a method includes determining whether a thermal risk exists for an occupant of a passenger compartment of a vehicle based on: (i) identifying, via a temperature sensor, that a temperature within the passenger compartment is outside of a safe temperature range; (ii) identifying, via an ECM of the vehicle, that an engine of the vehicle is not running; and (iii) identifying, via the occupant sensor, that an occupant is in the passenger compartment. In response to determining that the thermal risk exists, the method includes starting the engine via an ILS; closing power-actuated windows of the passenger compartment; locking power-locked doors of the passenger compartment; and activating an HVAC system of the vehicle via a CCU to maintain the temperature of the passenger compartment within the safe temperature range to safeguard the occupant until return of a responsible party.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts a block diagram of a thermal injury prevention (TIP) system, managed by a heatstroke prevention module (HPM), that is embedded in a vehicle, according to one or more embodiments;

FIG. 2 is a diagrammatic illustration of an exemplary hardware and software environment of a TIP system managed by a HPM, according to one or more embodiments;

FIG. 3 is a diagram of the TIP system detecting and responding a temperature risk to occupants of a vehicle, according to one or more embodiments; and

FIG. 4A-4B presents a flow diagram of a method for thermal injury prevention for occupants of a vehicle, according to one or more embodiments.

### DETAILED DESCRIPTION

According to aspects of the present disclosure, a vehicle, system, and method provide determining whether a thermal risk exists for an occupant of a passenger compartment of a vehicle based on: identifying, via the temperature sensor, that the temperature within the passenger compartment is outside of a safe temperature range, identifying, via an electronic control module, that an engine of the vehicle is not running, and identifying, via the occupant sensor, that an occupant is in the passenger compartment. In response to determining that the thermal risk exists, a controller starts starting the engine via an ignition locking system, closes power-actuated windows of the passenger compartment, locks power-locked doors of the passenger compartment, and activates a heating, ventilation and air conditioning system of the vehicle via a climate control unit. The HVAC maintains the temperature of the passenger compartment within the safe temperature range to safeguard the occupant until return of a responsible party.

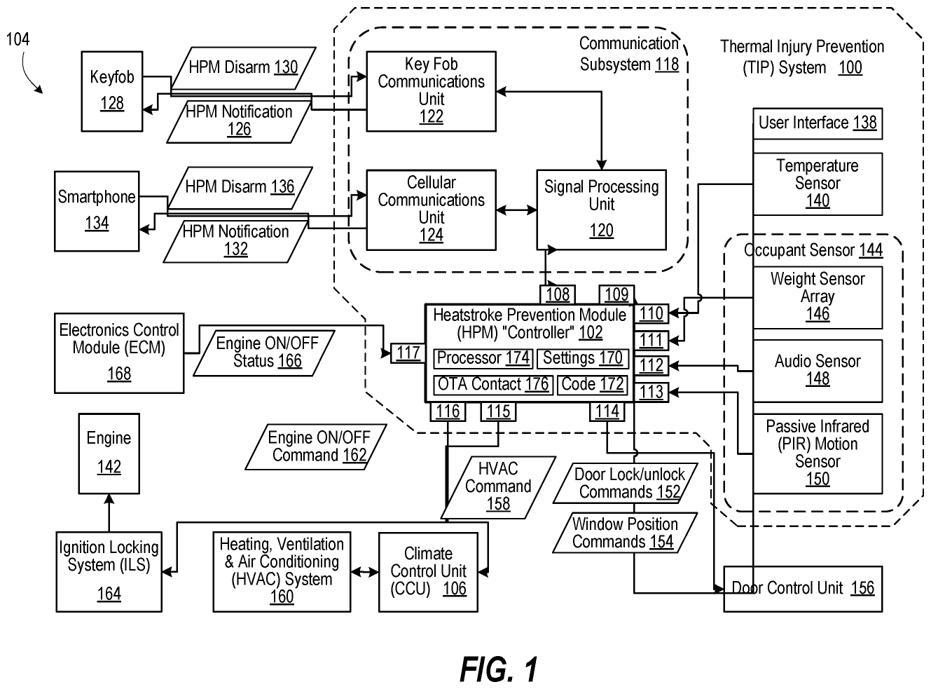

In one or more embodiments, FIG. 1 depicts a block diagram of a thermal injury prevention (TIP) system 100, managed by a heatstroke prevention module (HPM) or “controller” 102, that is embedded in a vehicle 104 such as an automobile. The TIP system 100 secures and protects the vehicle and its contents from intrusion while recognizing the presence of living beings and aids in the prevention of vehicular heatstroke or hypothermia without compromising the security of the passenger(s). The TIP system 100 utilizes various sensors to detect the presence of a living human or animal within the vehicle 104, while simultaneously monitoring the interior temperature of the vehicle. When a living being is detected and the temperature reaches a predefined temperature ceiling or floor, the TIP system 100 activates the heatstroke/hypothermia prevention module (HPM) 102, a sub-component of the TIP system 100, which then secures the vehicle by raising the windows (if lowered) and locking the doors (if unlocked).

Concurrently, the HPM 102 activates a climate control unit (CCU) 106 to maintain a safe temperature within the vehicle, preventing potential heatstroke/hypothermia of the living being. After a designated period of time, the system triggers an alert via electronic and auditory mechanisms. Finally, the system includes multiple fail-safes in the event of certain circumstances (for example, low battery, low fuel, or carbon-monoxide build-up) that trigger additional security and safety procedures.

In one or more embodiments, HPM 102 includes one or more interfaces 108-117 that communicatively couple HPM 102 to components internal or external to TIP system 100 within the vehicle 104. Interface 108 is connectable to a communication subsystem 118. In particular, interface 108 is connected to a signal processing unit 120 that in turn is connected to a short range radio transceiver such as a key fob communication unit 122 and a long range radio transceiver such as a cellular communications unit 124. In one or more embodiments, communication subsystem 118 is part of TIP system 100, such as being an after-market addition to capabilities of the vehicle 104. In one or more embodiments, communication subsystem 118 is a pre-existing capability of the vehicle 104. Key fob communication unit 122 can send HPM notifications 126 to a key fob 128 that responds by vibrating, displaying an alert, or producing an audible alarm. A user can initiate an HPM disarm notification 130 via the key fob 128 back to the key fob communications unit 122. Other communications can include arming or overriding specific actions by the TIP system 100. Similarly, cellular communications unit 124 can send HPM notifications 132 to a smartphone 134 that responds by vibrating, displaying an alert, or producing an audible alarm. A user can initiate an HPM disarm notification 136 via the smartphone 134 back to the cellular communications unit 124. Other communications can include arming or overriding specific actions by the TIP system 100.

In one or more embodiments, TIP system a user interface 138 that produces audible or visual information regarding system status or alerts. In one or more embodiments, interface 109 can connect to existing horns, speakers, lights or displays of the vehicle 104. In one or more embodiments, interface 109 can connect to dedicated user interface 138 that is separately powered from other capabilities of the vehicle 104.

TIP system 100 includes one or more temperature sensors 140 to detect an interior temperature in a passenger compartment of the vehicle 104. Temperature sensors 140 can include an exterior temperature. Temperature polling of temperature sensors 140 is available when the TIP system 100 is armed regardless of whether an engine 142 of the vehicle 104 or electrical accessories of the vehicle 104 are active.

TIP system 100 includes one or more occupant sensors 144 to detect the presence of an occupant in the passenger compartment. Occupants are living things that are susceptible to thermal injury. Examples of occupants include pets, infants, young children, and disabled or incapacitated adults. Occupant sensors 144 can include one or more of a weight sensor array 146, audio sensors 148, and passive infrared (PIR) motion sensors 150 communicatively coupled to HPM 102 respectively via interfaces 111-113. Interface 110 can be communicatively coupled existing seat sensors. Interface 110 can be communicatively coupled to additional weight sensors integrated into floor/rug panels, seats, etc.

HPM 102 can communicate, via interface 114, door lock/unlock commands 152 and window position commands 154 to a door control unit 156 of the vehicle 104. HPM 102 can communicate, via interface 115, HVAC commands 158 such as A/C or fan off/on to CCU 106 to control HVAC 160 the vehicle 104. HPM 102 can communicate, via interface 116, engine on/off commands 162 to ignition locking system (ILS) 164 that controls engine 142 of the vehicle 104. HPM 102 can communicate, via interface 117, engine on/off status 166 from electronics control module (ECM) 168 of the vehicle 104.

HPM 102 can be provisioned with configuration settings 170 for a specific configuration or a number of vehicles. HPM 102 can execute program code 172 executed by one or more processors 174 that enables the TIP system 100 to perform functions described herein. HPM 102 can be provisioned with codes and over-the-air (OTA) contact data 176 for reaching specific remote devices.

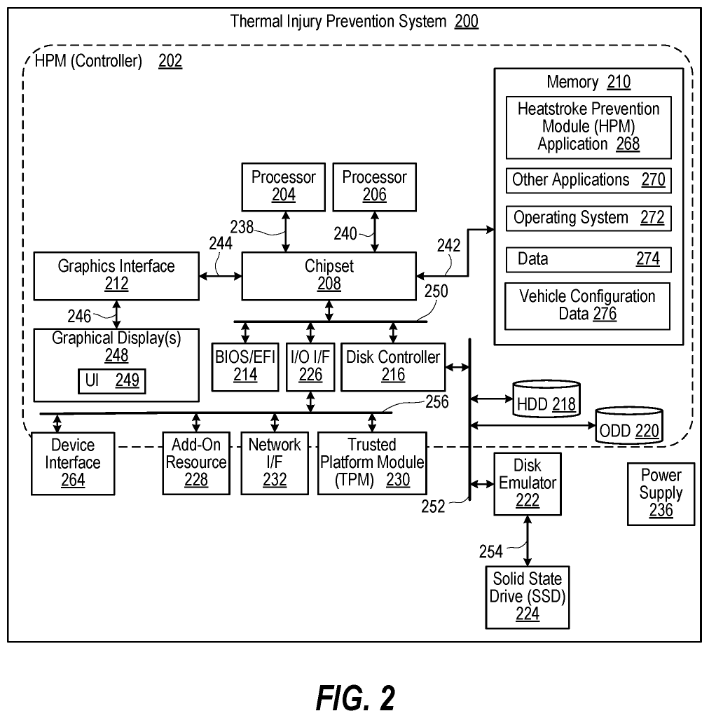

FIG. 2 is a diagrammatic illustration of an exemplary hardware and software environment of a TIP system 200 managed by a HPM (“controller”) 202 consistent with embodiments of the innovation. HPM 202 can be a customized implementation for the HPM 102 (FIG. 1) TIP system 200 is in part a customized information handling system (IHS) that performs at least a part of the methodologies and features as described herein. TIP system 200 can include processing resources for executing machine-executable code, such as a central processing unit (CPU), a programmable logic array (PLA), an embedded device such as a System-on-a-Chip (SoC), or other control logic hardware. TIP system 200 can also include one or more computer-readable medium for storing machine-executable code, such as software or data. Additional components of TIP system 200 can include one or more storage devices that can store machine-executable code, one or more communications ports for communicating with external devices, and various input and output (I/O) devices, such as a keyboard, a mouse, and a video display. TIP system 200 can also include one or more interconnects or buses operable to transmit information between the various hardware components.

TIP system 200 includes processors 204 and 206, chipset 208, memory 210, graphics interface 212, a basic input and output system/extensible firmware interface (BIOS/EFI) module 214, disk controller 216, hard disk drive (HDD) 218, optical disk drive (ODD) 220, disk emulator 222 connected to an external solid state drive (SSD) 224, input/output (I/O) interface (I/F) 226, one or more add-on resources 228, a trusted platform module (TPM) 230, network interface 232, and power supply 236. Processors 204 and 206, chipset 208, memory 210, graphics interface 212, BIOS/EFI module 214, disk controller 216, HDD 218, ODD 220, disk emulator 222, SSD 224, I/O interface 226, add-on resources 228, TPM 230, and network interface 232 operate together to provide a host environment of TIP system 200 that operates to provide the data processing functionality of the information handling system. The host environment operates to execute machine-executable code, including platform BIOS/EFI code, device firmware, operating system code, applications, programs, and the like, to perform the data processing tasks associated with TIP system 200.

In a host environment, processor 204 is connected to chipset 208 via processor interface 238, and processor 206 is connected to the chipset 208 via processor interface 240. Memory 210 is connected to chipset 208 via a memory bus 242. Graphics interface 212 is connected to chipset 208 via a graphics bus 244, and provides a video display output 246 to graphical display(s) 248 that presents UI 249. In a particular embodiment, TIP system 200 includes separate memories that are dedicated to each of processors 204 and 206 via separate memory interfaces. An example of memory 210 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 214, disk controller 216, and I/O interface 226 are connected to chipset 208 via an I/O channel 250. An example of I/O channel 250 includes a Peripheral Component Interconnect (PCI) interface, a PCI-Extended (PCI-X) interface, a high speed PCI-Express (PCIe) interface, another industry standard or proprietary communication interface, or a combination thereof. Chipset 208 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/EFI module 214 includes BIOS/EFI code operable to detect resources within TIP system 200, to provide drivers for the resources, initialize the resources, and access the resources. BIOS/EFI module 214 includes code that operates to detect resources within TIP system 200, to provide drivers for the resources, to initialize the resources, and to access the resources.

Disk controller 216 includes a disk interface 252 that connects the disk controller to HDD 218, to ODD 220, and to disk emulator 222. An example of disk interface 252 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 222 permits SSD 224 to be connected to TIP system 200 via an external interface 254. An example of external interface 254 includes a USB interface, an IEEE 1394 (Firewire) interface, a proprietary interface, or a combination thereof. Alternatively, solid-state drive 224 can be disposed within TIP system 200.

I/O interface 226 includes a peripheral interface 256 that connects the I/O interface to add-on resource 228, to TPM 230, and to network interface 232. Peripheral interface 256 can be the same type of interface as I/O channel 242, or can be a different type of interface. As such, I/O interface 226 extends the capacity of I/O channel 242 when peripheral interface 256 and the I/O channel are of the same type, and the I/O interface translates information from a format suitable to the I/O channel to a format suitable to the peripheral channel 256 when they are of a different type. Add-on resource 228 can include a data storage system, an additional graphics interface, a network interface card (NIC), a sound/video processing card, another add-on resource, or a combination thereof. Add-on resource 228 can be on a main circuit board, on separate circuit board or add-in card disposed within TIP system 200, a device that is external to the information handling system, or a combination thereof.

Network interface 232 represents a network interface controller (NIC) disposed within TIP system 200, on a main circuit board of the information handling system, integrated onto another component such as chipset 208, in another suitable location, or a combination thereof. Network interface 232 includes network channels 258, 259 and 260 that provide interfaces to devices that are external to TIP system 200. In a particular embodiment, network channels 258 and 260 are of a different type than peripheral channel 256 and network interface 232 translates information from a format suitable to the peripheral channel to a format suitable to external devices. An example of network channels 258-260 includes InfiniBand channels, Fibre Channel channels, Gigabit Ethernet channels, proprietary channel architectures, or a combination thereof. Network channels 258-260 can be connected to external network resources. The network resource can include another information handling system, a data storage system, another network, a grid management system, another suitable resource, or a combination thereof.

Within memory 210, HDD 218, ODD 220, or SSD 224, one or more software and/or firmware modules and one or more sets of data can be stored that can be utilized during operations of TIP system 200. These one or more software and/or firmware modules can be loaded into memory 210 during operation of the TIP system 200. Specifically, in one embodiment, memory 210 can include therein a plurality of such modules, including an HPM application 268, one or more other applications 270, operating system (OS) 272, and data 274. One example of data is airbag configuration data 276 These software and/or firmware modules have varying functionality as disclosed herein when their corresponding program code is executed by processors 204, 206.

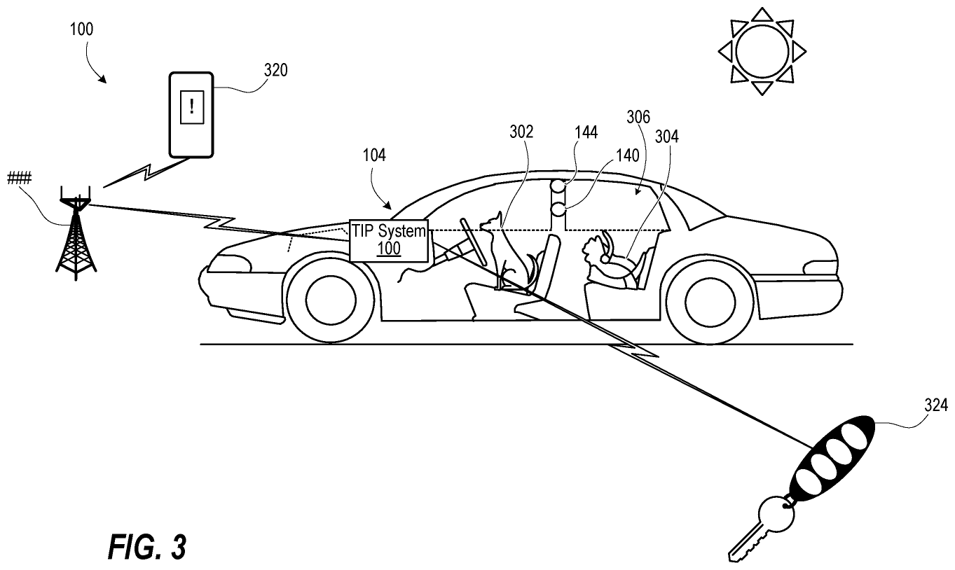

FIG. 3 is a diagram of the TIP system 100 detecting and responding a temperature risk to occupants of a vehicle 104. The HPM 102 (FIG. 1) determines whether a thermal risk exists for an occupant, such as a pet 302 and an infant 304 in a passenger compartment 306. To this end, the HPM 102 (FIG. 1) identifies, via the temperature sensor 140, that the temperature within a passenger compartment 306 of the vehicle 104 is outside of a safe temperature range. In particular, temperatures below the safe temperature range pose a likelihood of hypothermia. Temperatures below the safe temperature range pose a likelihood of hyperthermia, heat exhaustion, or heat stroke. The HPM 102 further identifies, via the ECM 168, that the engine is not running. The HPM 102 identifies, via the occupant sensor 144, that an occupant (200, 202) is in the passenger compartment 206. In response to determining that the thermal risk exists, the HPM 102 starts the engine via the ILS 164. The HPM 102 closes power-actuated windows 208 and locks power-locked doors 210. The HPM 102 activates the HVAC system 160 (FIG. 1) via the CCU 106 (FIG. 1) to maintain the temperature of the passenger compartment 204 within the safe temperature range to safeguard the occupant (200, 202) until return of a responsible party. The HPM 102 (controller), via the communication subsystem 118 (FIG. 1) identifies contact data for an over-the-air (OTA) communicating device used by the responsible party. For example, the OTA communicating device can be cellular device 220 that is reached via a radio access network (RAN) 222. For another example, the OTA communicating device can be wirelessly coupled key fob 224. The communication subsystem 118 (FIG. 1) transmits a notification of the thermal risk to the OTA communicating device (320, 324). The communication subsystem 118 (FIG. 1) can receive commands from the OTA communicating device (320, 324), such as to unlock the doors.

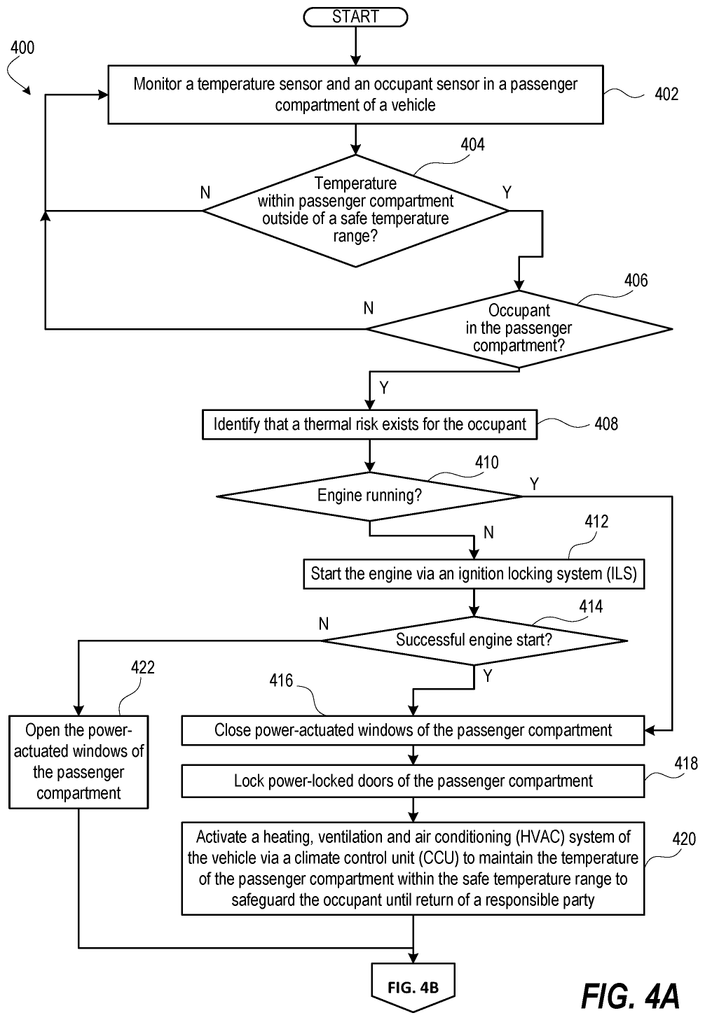

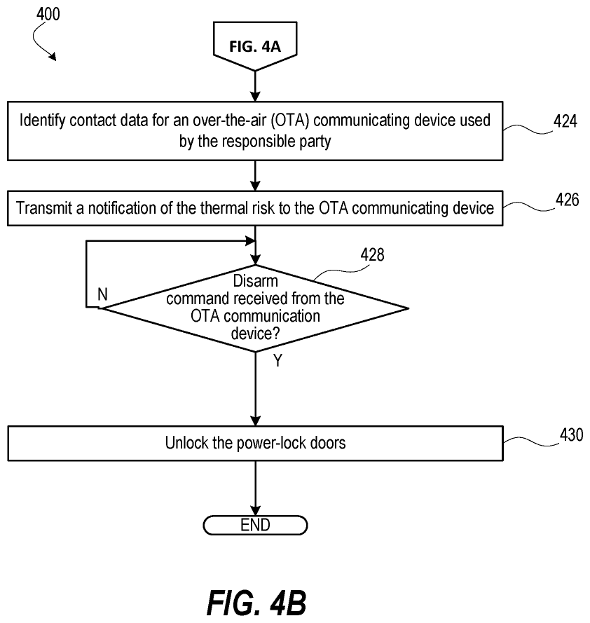

FIGS. 4A-4B present a flow diagram of a method 400 for thermal injury prevention for occupants of a vehicle. In particular, method 400 is directed to taking multi-faceted mitigations in response to determining that a thermal risk exists for an occupant of a passenger compartment a vehicle. In one or more embodiments, TIP system 100, managed by HPM or “controller” 102 (FIG. 1), perform method 400 in conjunction with other components referenced above for FIGS. 1-3. With reference to FIG. 4A, method 400 includes monitoring a temperature sensor and an occupant sensor in a passenger compartment of a vehicle (block 402). Method 400 includes determining whether, via the temperature sensor, that a temperature within the passenger compartment is outside of a safe temperature range (decision block 404). In response to the temperature being within the safe temperature range, method 400 returns to block 402. In response to the temperature being outside of the safe temperature range, method 400 includes determining, via the occupant sensor, whether an occupant is in the passenger compartment (decision block 406). In response to determining that there is not an occupant in the passenger compartment, method 400 returns to block 402. In response to determining that there is an occupant in the passenger compartment, method 400 includes identifying that a thermal risk exists for the occupant (block 408). Method 400 includes determining, via an electronic control module (ECM) of the vehicle, whether an engine of the vehicle is running (decision block 410). In response to determining that the engine is not running, method 400 includes starting the engine via an ignition locking system (ILS) (block 412). In one or more embodiments, starting the engine can include one or more attempts. In one or more embodiments, starting the engine can include restarting the engine. Method 400 includes determining whether starting the engine was successful (decision block 414).

In response to determining that starting the engine was successful, method 400 includes closing power-actuated windows of the passenger compartment (block 416). Method 400 includes locking power-locked doors of the passenger compartment (block 418). Closing the windows and locking the doors can protect the occupant from unauthorized access by third parties until first responders or the vehicle owner can return. Method 400 includes activating a heating, ventilation and air conditioning (HVAC) system of the vehicle via a climate control unit (CCU) to maintain the temperature of the passenger compartment within the safe temperature range to safeguard the occupant until return of a responsible party (block 420). In response to determining that starting the engine was not successful, method 400 includes opening the power-actuated windows of the passenger compartment (block 422).

Continuing in FIG. 4B, after performing either block 420 or 422, method 400 includes identifying contact data for an over-the-air (OTA) communicating device used by the responsible party (block 424). Method 400 includes transmitting a notification of the thermal risk to the OTA communicating device (block 426). Method 400 includes determining whether a disarm command is received from the OTA communication device (decision block 428). In response to determining that a disarm command is not received, method 400 returns to block 424. In response to determining that a disarm command is received, method 400 includes unlocking the power-lock doors (block 430). Then method 400 ends.

In the preceding detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A vehicle comprising:
a heating, ventilation and air conditioning (HVAC) system that comprises and is managed by a climate control unit (CCU);
an engine that provides operative power to the ECM;
an ignition locking system (ILS) communicatively coupled to start and stop operation of the engine;
an electronic control module (ECM) that provides an operational status of the engine;
a passenger compartment that is maintained within a safe temperature range by the HVAC system;
power-locked doors that selectively allow access to the passenger compartment;
power-actuated windows that selectively allow external airflow into the passenger compartment; and
a thermal injury prevention system comprising:
an occupant sensor to detect presence of a passenger in the passenger compartment;
a temperature sensor to detect a temperature within the passenger compartment; and
a controller that is communicatively coupled to the CCU of the HVAC system, the ILS, the ECM, the power locked doors, the power-actuated windows, the occupant sensor, and the temperature sensor, and which
determines whether a thermal risk exists for an occupant of the passenger compartment based on:
identifying, via the temperature sensor, that the temperature within the passenger compartment is outside of a safe temperature range,
identifying, via the ECM, that the engine is not running, and
identifying, via the occupant sensor, that an occupant is in the passenger compartment;
in response to determining that the thermal risk exists:
starts the engine via the ILS;
closes the power-actuated windows;
locks the power-locked doors; and
activates the HVAC via the CCU to maintain the temperature of the passenger compartment within the safe temperature range to safeguard the occupant until return of a responsible party.

2. The vehicle of claim 1, further comprising a communication subsystem that is communicatively coupled to the controller, wherein the controller, in response to determining that the thermal risk exists:
identifies contact data for an over-the-air (OTA) communicating device used by the responsible party; and
transmits a notification of the thermal risk to the OTA communicating device.

3. The vehicle of claim 2, wherein the controller in response to receiving a disarm command from the OTA communicating device, unlocks the power-lock doors.

4. The vehicle of claim 2, wherein:
the communication subsystem comprises a short range radio transceiver; and
the OTA communicating device comprises a key fob.

5. The vehicle of claim 2, wherein:
the communication subsystem comprises a cellular transceiver; and
the OTA communicating subsystem comprises a cell phone.

6. The vehicle of claim 1, wherein the controller:
determines whether the engine running after starting the engine via the ILS; and
in response to determining that the engine is not running, restarts the engine via the ILS.

7. The vehicle of claim 1, wherein the controller:
determines whether the engine running after starting the engine via the ILS; and
in response to determining that the engine is not running, lowers the power-actuated windows.

8. The vehicle of claim 1, wherein the occupant sensor comprises one or more of: (i) a weight sensor position in a seat of the passenger compartment; (ii) an audio sensor; and (iii) a passive infrared (PIR) sensor.

9. A thermal injury prevention system comprising:
an occupant sensor to detect presence of a passenger in a passenger compartment of a vehicle;
a temperature sensor to detect a temperature within the passenger compartment; and
a heatstroke prevention module (HPM) communicatively coupled to the occupant sensor and the temperature sensor and comprising a controller and one or more interfaces communicatively coupled to components of the vehicle, the components comprising:
a heating, ventilation and air conditioning (HVAC) system that is managed by a climate control unit (CCU),
an engine that provides operative power to the ECM,
an ignition locking system (ILS) communicatively coupled to start and stop operation of the engine,
an electronic control module (ECM) that provides an operational status of the engine,
a passenger compartment that is maintained within a safe temperature range by the HVAC system,
power-locked doors that selectively allow access to the passenger compartment,
power-actuated windows that selectively allow external airflow into the passenger compartment, wherein the controller:
determines whether a thermal risk exists for an occupant of the passenger compartment based on:
identifying, via the temperature sensor, that the temperature within the passenger compartment is outside of a safe temperature range,
identifying, via the ECM, that the engine is not running, and
identifying, via the occupant sensor, that an occupant is in the passenger compartment;
in response to determining that the thermal risk exists:
starts the engine via the ILS;
closes the power-actuated windows;
locks the power-locked doors; and
activates the HVAC via the CCU to maintain the temperature of the passenger compartment within the safe temperature range to safeguard the occupant until return of a responsible party.

10. The thermal injury prevention system of claim 9, further comprising a communication subsystem that is communicatively coupled to the HPM, wherein the controller, in response to determining that the thermal risk exists:
identifies contact data for an over-the-air (OTA) communicating device used by the responsible party; and
transmits a notification of the thermal risk to the OTA communicating device.

11. The thermal injury prevention system of claim 10, wherein the controller in response to receiving a disarm command from the OTA communicating device, unlocks the power-lock doors.

12. The thermal injury prevention system of claim 10, wherein:
the communication subsystem comprises a short range radio transceiver; and
the OTA communicating device comprises a key fob.

13. The thermal injury prevention system of claim 10, wherein:
the communication subsystem comprises a cellular transceiver; and
the OTA communicating subsystem comprises a cell phone.

14. The thermal injury prevention system of claim 9, wherein the controller:
determines whether the engine running after starting the engine via the ILS; and
in response to determining that the engine is not running, restarts the engine via the ILS.

15. The thermal injury prevention system of claim 9, wherein the controller:
determines whether the engine running after starting the engine via the ILS; and
in response to determining that the engine is not running, lowers the power-actuated windows.

16. The thermal injury prevention system of claim 9, wherein the occupant sensor comprises one or more of: (i) a weight sensor position in a seat of the passenger compartment; (ii) an audio sensor; and (iii) a passive infrared (PIR) sensor.

17. A method comprising:
determining whether a thermal risk exists for an occupant of a passenger compartment of a vehicle based on:
identifying, via a temperature sensor, that a temperature within the passenger compartment is outside of a safe temperature range,
identifying, via an electronic control module (ECM) of the vehicle, that an engine of the vehicle is not running, and
identifying, via the occupant sensor, that an occupant is in the passenger compartment; and
in response to determining that the thermal risk exists:
starting the engine via an ignition locking system (ILS);
closing power-actuated windows of the passenger compartment;
locking power-locked doors of the passenger compartment;
activating a heating, ventilation and air conditioning (HVAC) system of the vehicle via a climate control unit (CCU) to maintain the temperature of the passenger compartment within the safe temperature range to safeguard the occupant until return of a responsible party.

18. The method of claim 17, further comprising:
in response to determining that the thermal risk exists:
identifying contact data for an over-the-air (OTA) communicating device used by the responsible party; and
transmitting a notification of the thermal risk to the OTA communicating device. in response to receiving a disarm command from the OTA communicating device, unlocking the power-lock doors.

19. The method of claim 17, further comprising:
determining whether the engine running after starting the engine via the ILS; and
in response to determining that the engine is not running, restarting the engine via the ILS.

20. The method of claim 17, further comprising:
determining whether the engine running after starting the engine via the ILS; and
in response to determining that the engine is not running, lowering the power-actuated windows.
